(19) United States
(12) Patent Application Publication
(10) Pub. No.: US 2014/0379397 A1
(43) Pub. Date: Dec. 25, 2014

(54) METHOD, SYSTEM, AND/OR DEVICE FOR A COMMUNICATION NETWORK FOR REAL ESTATE PROFESSIONALS (REPS)

(71) Applicant: Agent Bridge, LLC, Rolling Hills Estates, CA (US)

(72) Inventors: Damian Walter Want, Redondo Beach, CA (US); Richard Kenneth Edler, Palos Verdes Estates, CA (US)

(21) Appl. No.: 13/924,498

(22) Filed: Jun. 21, 2013

(51) Int. Cl. G06Q 30/06

(52) U.S. Cl. CPC G06Q 30/0613
USPC 705/7.14; 705/345; 705/7.32; 705/26.41

(57) ABSTRACT

Embodiments of systems, methods and/or apparatus for a communication network for real estate professionals are provided.

### BACKGROUND

1. Field

This disclosure relates to a communication network for real estate professionals (REPs).

2. Information

Real estate professionals participate in real estate transactions in a myriad of ways. Real estate professionals, for example, may assist buyers and/or lessees by identifying real estate for sale or lease, negotiating details of a sale or lease agreement, and/or by assisting sellers or lessors in identifying suitable buyers and/or lessees that may be interested in a buying and/or leasing real estate and/or real estate-related a business opportunity. In any particular real estate transaction, there are often market-related values, such as for a property, exchanged between real estate professionals to initiate a transaction and to negotiate details of a transaction.

For example, in a transaction to sell a single family residence, a real estate professional (REP) representing a seller may list a seller's property on one or more online marketplaces accessible by the public and/or other real estate professionals. A typical residential listing may include a description of property features, such as property location, number of bedrooms or bathrooms, a tax lot or plat number, or the like. On the other side of a transaction, a real estate professional (REP) representing a buyer may search property listings to find a property which may be desirable for his or her buyer. If a property is identified, a buyer's REP may typically contact a seller's REP to further inquire into details, submit an offer, etc. This type of transaction may be representative of a real estate transaction that may occur thousands of times a day or more. Against this background, there may be a desire to provide useful techniques to assist real estate professionals (REPs).

### BRIEF DESCRIPTION OF DRAWINGS

Claimed subject matter is particularly pointed out and/or distinctly claimed in the concluding portion of the specification. However, both as to organization and/or method of operation, together with objects, features, and/or advantages thereof, may be understood by reference to the following detailed description if read with the accompanying drawings in which:

FIG. 1 is a schematic diagram illustrating an embodiment that may include a computing platform in accordance with claimed subject matter;

FIG. 2 is a flow diagram illustrating an embodiment of a method in accordance with claimed subject matter;

FIG. 3 is a flow diagram illustrating another embodiment of a method in accordance with claimed subject matter;

FIG. 4 is a flow diagram illustrating still another embodiment of a method in accordance with claimed subject matter;

FIG. 5 is a schematic diagram of an embodiment of a computing platform that may be employed to perform an embodiment of a method in accordance with claimed subject matter;

FIG. 6 through FIG. 9 depicts example non-limiting POPs listing property features in accordance with claimed subject matter.

FIG. 10 depicts an example webpage in accordance with an embodiment of claimed subject matter.

Reference is made in the following detailed description to accompanying drawings, which form a part hereof, wherein like numerals may designate like parts throughout to indicate corresponding and/or analogous components. It will be appreciated that components illustrated in figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and/or so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example,” “one feature,” “one embodiment,” “an example,” “a feature,” or “an embodiment” means that a particular feature, structure, and/or characteristic described in connection with a feature, example and/or embodiment may be included in at least one feature, example and/or embodiment of claimed subject matter. Thus, appearances of the phrase “in one example,” “an example,” “in one feature,” “a feature,” “an embodiment,” and/or “in one embodiment” in various places throughout this specification are not necessarily all referring to the same feature, example, and/or embodiment. Furthermore, particular features, structures, and/or characteristics may be combined in one or more examples, features, and/or embodiments.

As mentioned previously, there may be a desire to provide useful techniques to assist real estate professionals (REPs), such as to search for and/or identify real estate, and/or search for, identify and/or communicate with one or more real estate professionals in a more efficient and/or cost effective manner. In this context, a real estate professional, or “REP,” comprises a person appropriately licensed by an appropriate state authority to represent clients for a real estate transaction, such as a Realtor® professional, as a non-limiting example.

As mentioned above, a typical real estate transaction begins if a buyer's REP identifies a property and opens negotiations with a seller's REP. Here, in this example transaction, a buyer's REP may identify a property in various ways. One typical way, for example, may occur where a buyer's REP (or sometimes a buyer) searches for a property in a particular geographic area to identify a property that includes one or more features a buyer may find desirable. One common way to search for a property is to review property listings, such as may be posted via online marketplaces, for example.

Currently many REPs, for example, subscribe to one or more property listing services, such as the Multiple Listing Service, or MLS®. MLS®, for example, includes property listings relating to sales, market, and/or tax-related history, and/or other property-related feature descriptions, such as number of bedrooms, bathroom, square footage, and the like, for a particular property, whether a property is currently for sale, pending, or previously sold, as some non-limiting examples. A listing may typically be compiled from country tax records and/or submitted by one or more REPs. Multiple Listing Services and/or online marketplaces, such as MLS® or other systems, such as LoopNet® service (more typically used for business and/or commercial property), are widely used by REPs in the course of business. Many services and/or online marketplaces may also be accessible to the public, albeit often with reduced functionality. Here, it is noted that MLS and LoopNet® type-services are merely example online marketplaces and/or services.

Though services and/or marketplaces enjoy wide adoption, there may be various issues with use. One issue, as just an example, may be that a buyer REP may find it challenging to get one or more potential listings, one or more off-market listings, one or more pre-listings, and/or combinations thereof, associated with another REP. In this context, a “POPs listing” for an REP refers to one or more potential listings, one or more off-market listings, one or more pre-listings, and/or combinations thereof.

As just an example, a “potential listing” may comprise a property that a seller may intend to sell, but the seller, for example, may not yet want publically listed. This situation may occur for various reasons. One reason, for example, may be that a seller may desire to gauge demand and/or price for his/her property before publicly making a price commitment. This may be advantageous for a seller since REPs typically use regression analysis and/or comparables (“comps”) to price homes or other real estate. That is, REPs commonly look at prices of comparable properties, or comps, to set a price of a property to be listed. Thus, a potential listing seller may desire to gauge demand and, therefore, price, prospectively. Of course, this is merely one example of a “potential listing” and claimed subject matter is not limited in this regard.

As yet another example, an “off-market listing” may comprise a property in which a seller may contract with a REP to sell, but the seller may choose to not list a property on the market publically. This situation may also occur for various possible reasons. One reason, for example, may be that a seller may be concerned about security or privacy issues associated with a public listing. For example, at least some publically available listing services require disclosure of property address, tax identification number, or items viewed as sensitive. It is not uncommon for potential buyers to drive by a property and look in the windows, etc. Likewise, commercial or business sellers may not want to deter customers, alert employees, or the like, as may happen with a public listing. Of course, this is merely one example of an “off-market listing” and claimed subject matter is not limited in this regard.

As yet another example, a “pre-listing” may comprise a property in which a seller may contract with a REP to sell, but the seller may desire to withhold (e.g., delay) a public listing for a certain period of time. Again, a seller may choose to do this for several reasons; some example reasons were expressed previously in situations discussed earlier, such as prospective pricing and/or to increase privacy, as non-limiting examples. Yet another reason, as just an example, may be that a public listing becomes part of the “public record.” That is, after a public listing, anyone is able find out that a seller is trying to sell his or her property and also find out the price. A record may be considered to be detrimental for a seller, especially where a seller later choses to keep a property and/or remove the listing. The prior listing may make it difficult for a seller to later list the property at a different price, may make it difficult for the seller to refinance the property, and/or may affect valuation of neighboring properties, as just some examples. Of course, this is merely one example of a “pre-listing” and claimed subject matter is not limited in this regard.

Another issue with current services and/or marketplaces may be that an REP may find it challenging to identify another REP to which one may refer a client. For example, geographic scope of an REP's license and/or an REP's subscription to a particular online marketplace, such as MLS®, may likewise be geographically limiting, such as in terms of potential representation or otherwise. Accordingly, at times, an REP may desire to refer a buyer or seller to another REP that may service another geographic location in which a buyer or seller may be interested, for example. Currently, for example, it is estimated that referrals account for roughly 7% of an REP's business. In addition, an REP may earn approximately 20% to approximately 45% in commission, which may, of course, vary with a variety of factors, including particular market, for referring a client to another REP.

Currently, there are several ways to locate a REP in other geographic locations to which one may desire to refer a client. One way, for example, may comprise a referring REP (e.g., a client's current REP) (also called a referrer REP in this context) knowing of a referral REP (e.g., a REP that may engage with the client after a referral by a referrer REP) (also called a referee REP in this context) in a location of interest. If not, the referring REP (or referrer REP) may attempt to identify a referral REP (or referee REP), such as by an online search, as an example, or by “word of mouth” or other ad hoc approaches.

In this situation, such as where a referral REP is not known to a referring REP, it may be challenging for a referring REP to assess skills, abilities, customer service, knowledge, and/or credentials of a referral REP. Accordingly, a referring REP may be reluctant to refer his or her client to a referral REP, for example, without investigation, which may be time-consuming, inconvenient and/or cumbersome.

Similarly, in a situation where a referring REP is satisfied with credentials of a referral REP, a referring REP may still be reluctant to refer his or her client until a referral fee agreement has been negotiated and consummated. Here, for example, a referring REP may email, fax or otherwise send over a referral fee agreement to a referral REP in hopes of an agreement. Occasionally, fee agreement negotiations may be complex. For example, a referral fee agreement may specify referral fee amount, timing of payment, spell out contingencies, and/or contain other terms and/or conditions, all of which are to be negotiated and then agreed upon by the referring and referral REPs. In addition, referral fee agreements may have added complexity if dealing with interstate and/or international referrals. For example, there may be a patchwork of international, national, state and/or local laws, in addition to regulatory licensing bodies, to be taken into account in a referral fee agreement. These issues may contribute to a less robust referral market than might otherwise be achieved.

As a related issue, if a client has been successfully referred to a referral REP, it may be challenging for the referring professional to track his/her client's progress in a real estate transaction with the referral REP. Currently, client tracking may rely on a referring REP calling or emailing the referral REP to get updates, or vice versa, as just an example. This process may be commonplace, but is typically inefficient; despite that, many referring REPs have a continued stake in a transaction. For example, many referral fee agreements pay a referring professional at the close of a real estate transaction. Thus, referring professionals may desire to stay informed of progress in a more efficient and/or transparent manner.

Yet another issue with many online services and/or marketplaces, such as MLS® or LoopNet®, for example, may be that many services appear to focus on a consumer to REP interaction and/or communications, rather than on an REP to REP interaction and/or communications. Accordingly, services and/or marketplaces of this type, for example, may not include tools that may measurably be expected to increase efficiency and/or improve communications for an REP, for example.

Accordingly, with these and other considerations in mind, via illustration, in embodiments, a system, method and/or device for a communication network for REPs is described. It is noted without loss of generality that in this context the term ‘communication network’ or the term ‘computing network’ is meant to refer to a communications and/or computing network, such as, without limitation, embodiments as described in more detail below. One aspect of implementing an REP communication network, in certain embodiments, for example, may involve determinations or matches of performance and/or expertise, which may, for example, be made by comparisons of performance and/or expertise indicia, which may, in an embodiment, be associated with a referral REP's profile. By way of non-limiting example, a referral REP's designations (e.g., CRS, GRI, ePro, etc.), referral REP's sales in zip code, referral REP's sales over a price point, and the like, may be the subject of comparison operations. Likewise, in embodiments, one or more comparison operations may compare one or more referral REP's performance and/or expertise indicia, such as may, for example, in an embodiment, be entered by a referring REP with one or more performance and/or expertise indicia indexed as a part of a referral REP's networked profile, for an embodiment, as described in more detail later.

In certain embodiments, without limitation, determinations of performance and/or expertise may be made utilizing a score. Of course, where scoring is used, one or more components may be measured, estimated and/or quantified to produce a score. Here, it is noted that for a particular measurement, whether measuring REP performance parameters, REP experience parameters, or the like, for example, a typical measurement model employed is that a measurement taken comprises a sum of at least two components, a deterministic component, which in an ideal sense, comprises a value sought as a result of taking a measurement, and a random component, which may have a variety of sources that may be challenging to quantify accurately. Thus, a statistical model may be used. A large number of measurements may be collected, for example, to better estimate a deterministic component.

Likewise, where measurements vary, some portion of a variance may be explained as a deterministic component while some portion of a variance may be explained as a random component. Likewise, a deterministic component may be subject to change, adding further uncertainty potentially. Typically, it is desirable to have a variance associated with and/or modeled as statistically random factors that are relatively small, if feasible, relative to a deterministic component, for example

Along these lines, a variety of techniques have come into use so that measurements may be processed to better estimate an underlying deterministic component, as well as realized random components, typically. These techniques may vary with a particular situation. Typically, however, more complex problems involve more complex techniques. In this regard, measuring REP performance parameters and/or REP experience parameters may be similar to an estimation of other measurable characteristics. Measurements may be collected. Employing a model permits collected measurements to be processed to estimate an underlying deterministic component. Although a given estimate may not be a perfect estimate, such as, if it may change, for example; nonetheless, in general, it is expected that on average an estimate may better reflect an underlying deterministic component if random components that may be included in measurements are considered. Practically speaking, of course, it is desirable to be able to generate, such as through estimation approaches, a meaningful model of processes affecting measurements.

In some situations, as indicated, potential influences may be complex, as in the case of measuring REP performance parameters and/or REP experience parameters across a broad spectrum of international, national, and/or local marketplace and across a broad spectrum of residential, commercial and/or rental transactions. Therefore, seeking to understand appropriate factors to consider for generating estimates of REP performance parameters and/or REP experience parameters may be particularly challenging. For example, here, as only a few examples, influences of geographic location, varying and/or disparate certifications, seasonal and/or cyclical market forces, currency fluctuations, and/or the like, may add to measurement complexity. In such situations, it is, therefore, not unusual to employ heuristics in connection with generating estimates. Heuristics refers to use of experience related approaches that may reflect realized processes and/or realized results, such as in connection with use of historical measurements, for example. Heuristics, for example, may be employed in situations, such as this, where more analytical approaches may be overly complex and/or nearly intractable to implement computationally.

With advances in technology, such as for networking, it has become typical to employ a distributed computing and/or communication approach, such as for a network, which may, for example, therefore, include one or more clients and one or more servers, mutually coupled, for example, via a computing and/or communications network. A network may comprise two or more network devices and/or may couple network devices so that signal communications, such as in the form of signal packets, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets), such as via a wired or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof. Signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. Likewise, in an embodiment, both a client and a server may be integrated together in a single device, for example. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities, including measurements, and are intended to merely be convenient labels.

Likewise, in this context, the terms “coupled”, “connected,” and/or similar terms may be used generically. It should be understood that these terms are not intended as synonyms. Rather, “connected” if used generically may be used to indicate that two or more components, for example, are in direct physical and/or electrical contact; while, “coupled” if used generically may mean that two or more components are in direct physical or electrical contact; however, “coupled” if used generically may also mean that two or more components are not in direct contact, but may nonetheless co-operate or interact. The term coupled may also be understood generically to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description and/or usage may provide helpful guidance regarding inferences to be drawn.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as computing and/or communication protocols (e.g., network protocols), may interoperate within a larger network. In this context, the term sub-network refers to a portion or part of a network. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link or connection between otherwise separate and/or independent LANs. In this context, a private network refers to a particular, limited set of network devices able to communicate with other network devices in the particular, limited set, such as via signal packet transmissions, for example, without a need for re-routing and/or redirecting such network communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. It is understood in this context that a private network may provide outgoing network communications to devices not in the private network, but such devices outside the private network may not direct inbound network communications to devices included in the private network.

The Internet refers to a decentralized global network of interoperable networks that comply with the Internet Protocol (IP). It is noted that there are several versions of the Internet Protocol. Here, the term Internet Protocol or IP is intended to refer to any version, now known or later developed. The Internet includes local area networks (LANs), wide area networks (WANs), wireless networks, and/or long haul public networks that, for example, may allow signal packets to be communicated between LANs. The term world wide web (WWW) and/or similar terms may also be used, although it refers to a sub-portion of the Internet that complies with the Hypertext Transfer Protocol or HTTP. It is noted that there are several versions of the Hypertext Transfer Protocol. Here, the term Hypertext Transfer Protocol or HTTP is intended to refer to any version, now known or later developed. It is likewise noted that in various places in this document substitution of the term Internet with the term world wide web may be understood to also be made without a significant departure in meaning and may, therefore, not be inappropriate in that the statement would remain correct with such a substitution.

Signal packets, also referred to as signal packet transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address. Although the Internet comprises a network of interoperable networks, not all of those interoperable networks are necessarily available or accessible to the public.

Physically connecting a network via a hardware bridge is sometimes done, although a hardware bridge may not typically include a capability of interoperability via higher levels of a network protocol. A network protocol refers to a set of signaling conventions for computing and/or communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance and/or substantial compatibility.

Typically, a network protocol has several layers. These layers may be referred to here as a network stack. Various types of network transmissions may occur across various layers. For example, as one moves higher in a network stack, additional operations may be available by initiating network transmissions that are compatible and/or compliant with a particular network protocol at these higher layers. Therefore, for example, a hardware bridge may be unable to forward signal packets since it may operate at a layer of a network stack that does not provide that capability. Although higher layers of a network protocol may, for example, affect device permissions, user permissions, etc., a hardware bridge, for example, may typically provide limited user control, such as for higher layer operations. Therefore, often, a combined hardware and software platform, as an example, may be employed.

A VPN, for example, often implemented in software, may enable a remote device to communicate via a local network. A router may allow network communications in the form of network transmissions (e.g., signal packets), for example, to occur from a remote device to a VPN server on a local network. A remote device may be authenticated and a VPN server, for example, may create a special route between a local network and the remote device through an intervening router. A route may be generated and/or also regenerate if the remote device is power cycled, for example. A VPN may at times affect a single remote device; however, situations may exist in which multiple remote devices are affected as a result of a VPN.

A network may be very large, such as comprising thousands of nodes, millions of nodes, billions of nodes, or more, as examples. Although a router may link otherwise independent LANs through routing of signal packets, a router may also provide some limits on signal packet transmissions to a select set of devices, for example. A router may limit signal packet transmissions via implicitly or explicitly producing a broadcast domain (also referred to as BD or as a broadcast domain). In this context, the term broadcast domain refers to a set of devices, including associated services and/or support, occupying an address space, such as a local network address space, in which any device is able to communicate with any other device in the broadcast domain without rerouting a transmission, such as a signal packet. For example, a signal packet may be transmitted to other devices in the broadcast domain without being directed or redirected via a router or similar device, such as a device capable of affecting routing of signal packets, for example. Using a router or a similar device able to perform network address translation (NAT), portions of networks may be logically separate and independent such that transmissions in the form of signal packets by a network device on a network, for example, may not necessarily be forwarded from the BD unless a destination having a particular destination address of a signal packet transmission exists outside the particular broadcast domain.

Examples of broadcast domains may include virtual BDs, physical BDs or BDs that include both virtual and physical components. For example, in this context, a physical BD refers to a traditional BD comprising a set of physical devices, in which a physical device is able to communicate with another physical device in the broadcast domain, e.g., as previously explained, without being rerouted. For example, a signal packet may be transmitted from one device in the BD to another device in the BD without being directed or redirected via a router or similar device, such as a device capable of affecting routing of signal packets, for example. In contrast, a virtual BD refers to a BD that employs virtual components within the BD. A virtual BD operates like a physical BD, but is not physically part of the BD. An example may include a VPN or virtual private network, for example. Thus, another example of a BD may include physical devices along with one or more VPNs, for example. The term broadcast domain is also used in a generic sense meaning that it is not limited exclusively to a broadcast type of signal packet transmission scheme and may include in addition to and/or in place of a broadcast, other types of signal packet transmission schemes, such as, but not limited to, anycast, broadcast, multicast, unicast, geocast, the like, or any combinations thereof.

As previously indicated, a network device comprises a device capable of communicating via a network. For example, network devices may comprise computing devices, non-computing devices, or other devices. A network device may comprise a router, gateway, hub, switch, host, mobile device, server, client, the like, or any combinations thereof. A server may comprise a network device capable of serving content. For example, a server may provide now known or to be later developed, server arrangements, derivatives, and/or improvements, including past, present, or future services comprising, but not limited to, web services, third-party services, audio services, video services, email services, instant messaging (IM) services, SMS services, MMS services, voice over IP (VOIP) services, calendaring services, photo services, database services, facsimile services, file services, domain name services, game services, printing services, proxy services, data streaming services, peer-to-peer services, other services, the like or any combinations thereof. Examples of content may include text, images, audio, video, the like, or any combinations thereof, which may be processed in the form of physical signals, such as electrical signals, for example, or may be stored in memory, as physical states, for example.

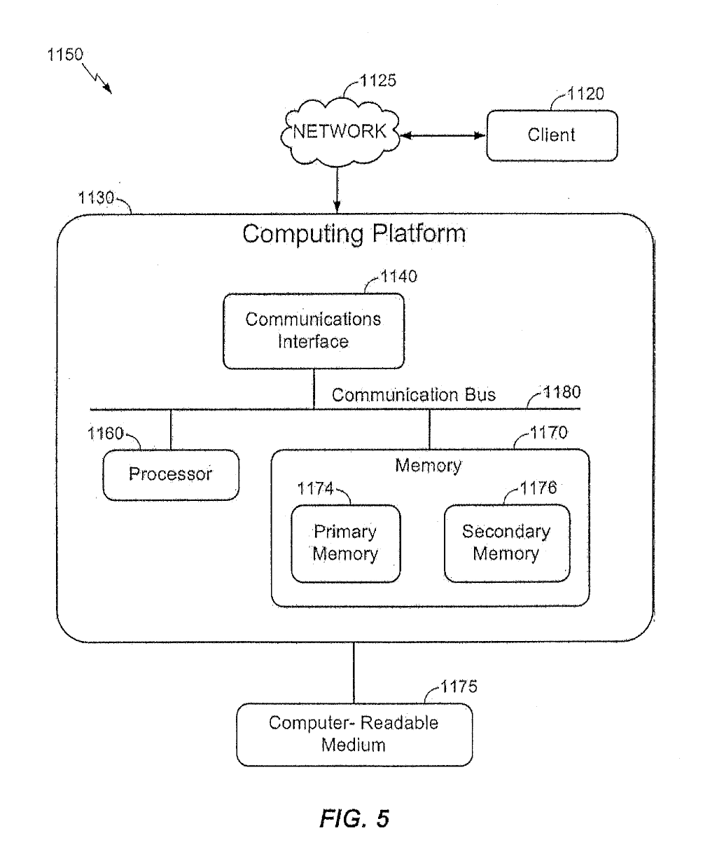

For purposes of illustration, FIG. 5 is an illustration of an embodiment of a computing platform 1150 that may be employed in a client-server type interaction, such as with electronic communications, such as described herein, for example, in connection with rendering a graphical user interface (GUI) via a device, such as a network device and/or a computing device, for example. Typically, a server may comprise one node of a network and a client may comprise another node of a network, for example. Therefore, the client and server typically are able to exchange electronic communications via the network.

In FIG. 5, computing platform 1130 may interface with client 1120, which may comprise features of a conventional client device, for example. Communications interface 1140, processor (e.g., processing unit) 1160, and memory 1170, which may comprise primary memory 1174 and secondary memory 1176, may communicate by way of communication bus 1180, for example. In FIG. 5, client 1120 may represent one or more or more sources of analog, uncompressed digital, lossless compressed digital, or lossy compressed digital formats for content of various types, such as video, imaging, text, audio, etc. in the form physical states or signals, for example. Client 1120 may communicate with computing platform 1130 by way of an Internet connection via network 1125, for example. Although the computing platform of FIG. 5 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter be limited in scope to illustrative examples.

Processor 1160 may be representative of one or more circuits, such as digital circuits, to perform at least a portion of a computing procedure or process. By way of example, but not limitation, processor 1160 may comprise one or more processors, such as controllers, microprocessors, microcontrollers, application specific integrated circuits, digital signal processors, programmable logic devices, field programmable gate arrays, and the like, or any combination thereof. In implementations, processor 360 may perform signal processing to manipulate signals or states and/or to construct signals or states, for example.

Memory 1170 may be representative of any storage mechanism. Memory 1170 may comprise, for example, primary memory 1174 and secondary memory 1176, additional memory circuits, mechanisms, or combinations thereof may be used. Memory 370 may comprise, for example, random access memory, read only memory, or one or more data storage devices or systems, such as, for example, a disk drive, an optical disc drive, a tape drive, a solid-state memory drive, just to name a few examples. Memory 1170 may be utilized to store a program. Memory 1170 may also comprise a memory controller for accessing computer readable-medium 1175 that may carry and/or make accessible content, code, and/or instructions, for example, executable by processor 1160 or some other controller or processor capable of executing instructions, for example.

Under direction of processor 1160, memory, such as memory cells storing physical states, representing for example, a program, may be executed by processor 1160 and generated signals may be transmitted via the Internet, for example. Processor 1160 may also receive digitally-encoded signals from client 1120.

Network 1125 may comprise one or more network communication links, processes, services, applications and/or resources to support exchanging communication signals between a client, such as 1120 and computing platform 1130, which may, for example, comprise one or more servers (not shown). By way of example, but not limitation, network 1125 may comprise wireless and/or wired communication links, telephone or telecommunications systems, Wi-Fi networks, WiMAX networks, the Internet, a local area network (LAN), a wide area network (WAN), or any combinations thereof.

The term “computing platform,” as used herein, refers to a system and/or a device, such as a computing device, that includes a capability to process (e.g., perform computations) and/or store measurements, for example, in the form of signals and/or states. Thus, a computing platform, in this context, may comprise hardware, software, firmware, or any combination thereof (other than software per se). Computing platform 1130, as depicted in FIG. 5, is merely one such example, and scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 1170 may store cookies relating to one or more users and may also comprise a computer-readable medium that may carry and/or make accessible content, code and/or instructions, for example, executable by processor 1160 or some other controller or processor capable of executing instructions, for example. A user may make use of an input device, such as a computer mouse, stylus, track ball, keyboard, or any other similar device capable of receiving user actions and/or motions as input signals. Likewise, a user may make use of an output device, such as a display, a printer, etc., or any other device capable of providing signals, generating visual or audio stimuli or other similar output stimuli for a user.

Regarding aspects related to a communication and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, or the like coupled by wireless radio links, and/or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology, other technologies, and/or the like. Network access technologies may enable wide area coverage for devices, such as client devices with varying degrees of mobility, for example.

A network may enable radio frequency or other wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device, such as a computing device and/or a network device, between or within a network, or the like.

Communications between a computing device and/or a network device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device and/or a networking device may also have a subscriber identity module (SIM) card, which, for example, may comprise a detachable smart card that is able to store subscription related content of a user, and/or is also able to store a contact list of the user. A user may own the computing device and/or networking device or may otherwise be a user, such as a primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad or other display of limited functionality, such as a monochrome liquid crystal display (LCD) for displaying text, for example. In contrast, however, as another example, a web-enabled device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing and/or network device may include or may execute a variety of now known, or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include or may execute a variety of possible applications, such as a client software application enabling communication with other devices, such as communicating one or more messages, such as via email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include or execute a software application to communicate content, such as, for example, textual content, multimedia content, and/or the like. A computing and/or network device may also include or execute a software application to perform a variety of possible tasks, such as browsing, searching, playing various forms of content, including locally stored or streamed video, or games, such as, but not limited to, fantasy sports leagues. The foregoing is provided merely to illustrate that claimed subject matter is intended to include a wide range of possible features or capabilities.

A network may also be extended to another device communicating as part of another network, such as via a virtual private network (VPN), as mentioned. To support a VPN, broadcast domain transmissions may be forwarded, as mentioned, to the VPN device via another network. For example, a software tunnel may be created between a broadcast domain, and a VPN device. Tunneled traffic may, or may not be encrypted, and a tunneling protocol may be substantially compliant with and/or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets, such as in a network of participating digital communications, A broadcast domain may be compatible with now known, or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A broadcast domain may employ, for example, TCP/IP, UDP, DECnet, NetBEUI, IPX, Appletalk, other, and/or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, and/or other system, such as a computing device and/or a network device, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In one implementation, as just an example, a communication network may comprise a virtual private network (e.g., VPN), such as of a type as previously described, for example, accessible by REPs that may facilitate transactions in domestic and/or international real estate markets for residential, commercial, and/or rental markets, as just an example. In one implementation, as just an example, a communication network may allow REPs to identify and view and/or request additional content with respect to one or more POPs listings associated with another REP, for example. In one implementation, as just an example, a communication network may alert an REP if another REP has entered or otherwise provided buyer-related content that may “match” one or more of POPs listings of a REP. In at least one embodiment, for example, matching may comprise having sufficiently similar or sufficiently close scores, as explained in more detail below. In one implementation, as another example, a communication network may score one or more measured parameters of one or more REPs that may be included in a communication network, such as, for example, a private REP electronic computing and communication network, in an embodiment. For example, in one or more embodiments, as described in more detail below, scoring may be used to identify potential matches of REPs in the network based at least in part on measurements of combinations of performance, location and/or expertise. It is noted that in this context, the term match is not meant to refer to a perfect or identical match. Rather, the term match, as shall be made more clear with illustrations, is intend to refer to identifying via various measurements and/or indicia, for example, sufficient similarity, among items being compared, so that, in accordance with various sets of criteria, which may be modified or user specified, for example, heuristic approaches, for example, suggest further interaction or communications have a potential to be fruitful, such as in terms of leading to a transaction, for example.

In one implementation, as another example, a communication network may generate referral fee agreement terms and, subject to appropriate levels of electronic security and/or express electronic permissions being granted, for example, may be employed to electronically transmit referral communications to one or more REPs identified to be sufficiently similar based at least in part on processing in connection with user specified or system generated criteria, for example. In one implementation, as another example, a communication network may notify referring REPs of client progress where a client has been referred to a referral REP, assuming, of course, both REPs are included within an electronic computing and communication network for REPs, even though a private network, for example. Of course, the above examples are merely illustrative; accordingly, scope of claimed subject matter is not limited by such examples and/or illustrations.

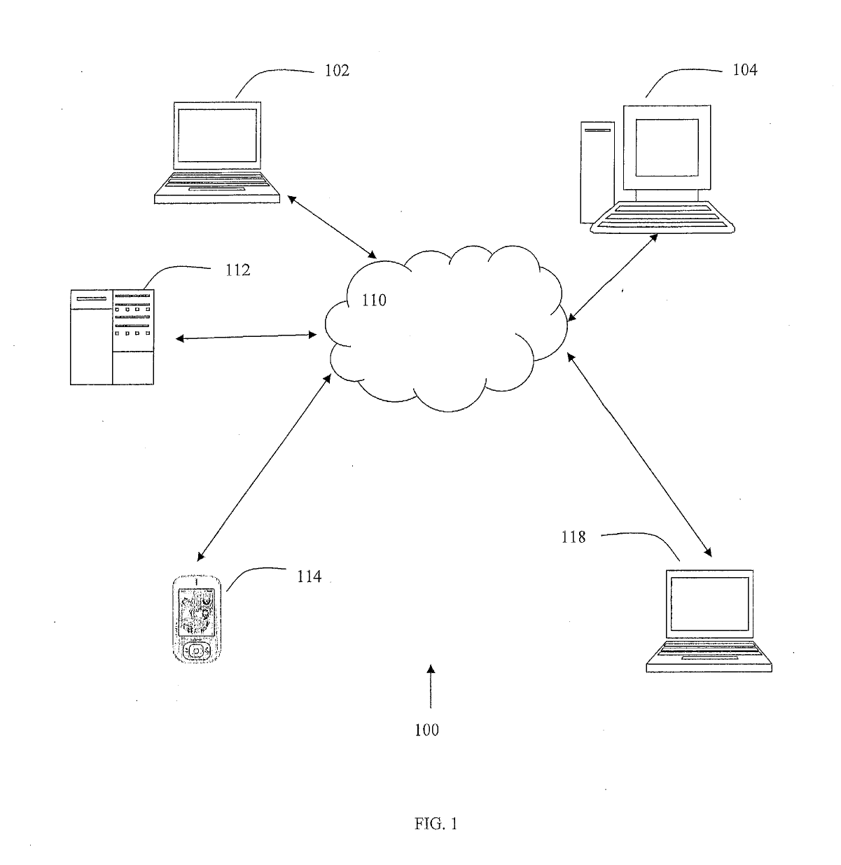

FIG. 1 is a schematic diagram depicting embodiment 100 of a system for a computing and communication network for REPs, such as a private network. In embodiment 100, one or more computing platforms, which may include one or more computing devices, for example, such as computing platforms 102, 104, 114 or 118, may be communicatively coupled to network 110. In this example, computing platform 102, 104, 114 and 118, though depicted as particular types of computing platforms, are in no way limited to the computing platforms depicted and/or to use of a particular computing device within respectively shown computing platforms; rather, a computing platform may take a variety of other forms. It is noted, as previously discussed, that a computing platform is intended to include at least hardware, such as a computing device, and software capable of executing on the hardware to thereby make the computing platform a special purpose apparatus or machine in term of capabilities that may be executed in accordance with software executing on the particular computing device(s), for example. Of course, a computing platform in this context may also include other components, as well, such as firmware, flash memory, etc.

Here, in this example, computing platform 102, 104, 114 or 118 may comprise a computing platform associated with one or more REPs, such as a client device, an application program executing on a client device, an application program interface executing on a client device, and/or combination thereof, which may be utilized to communicatively couple to network 110. It is understood in this context that a client device illustrates an example of a computing platform and is meant to include hardware, again, such as a computing device; although, as previously described, a client device also likewise includes software capable of executing so that the particular client device may comprise a special purpose apparatus or machine. Thus, for example, one or more REP may make an electronic entry via a client device or participate in an electronic interaction via one or more actual or virtual buttons or keys, one or more hyperlinks, or the like, as non-limiting examples, such as may be associated with computing platform 102, 104, 114 or 118, such as capable of being generated and/or included as part of computing platforms 102, 104, 114 or 118, so as to include electronic communications, such as via network 110, to computing platform 112, as just an example.

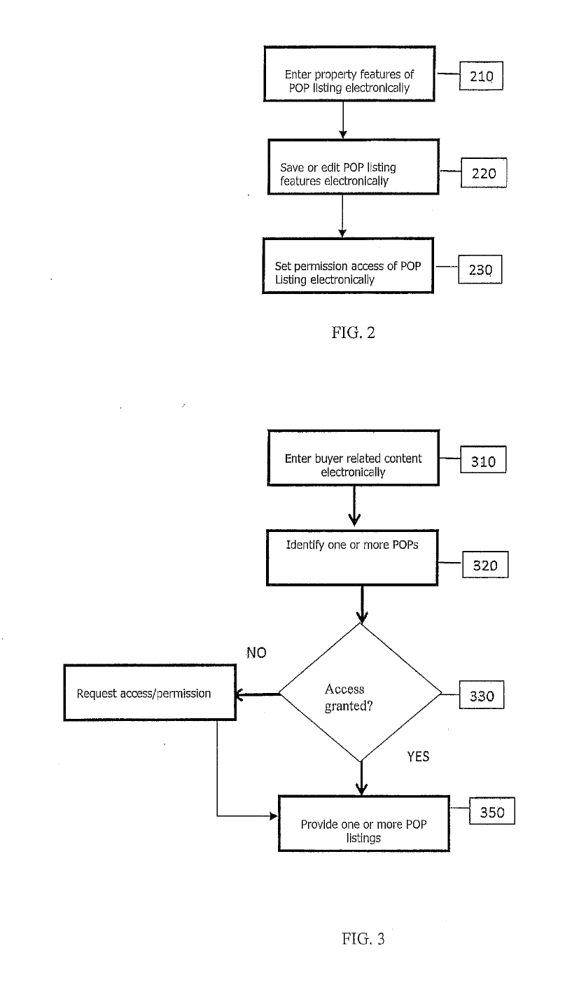

Though depicted as a single computing platform, computing platform 112 may comprise one or more computing platforms, such as one or more web servers, one or more databases, one or more message creating computing platforms, one or more computing platforms having one or more other functional roles, and/or any combinations thereof. In this example, computing platform 112 may be operable to perform one or more operations, such as those depicted in FIGS. 2-5, as just an example, described in more detail below. It should, however, be noted that operations depicted in FIGS. 2-5 are merely illustrative examples relating to a system and that claimed subject matter is not limited in scope this regard. Claimed subject matter in general is not intended to be limited to illustrative examples.

FIG. 2 is a flow diagram illustrating an embodiment 200 of a method that may be employed in conjunction with a communication network for REPs, for example. Method embodiment 200 of FIG. 2, along with other figures shown and/or described herein, may be performed by computing device 112, for example, although nothing prevents performing other method embodiments within claimed subject matter. Likewise, a method embodiment, such as embodiment 200, may be performed by way of other arrangements other than an embodiment such as shown in FIG. 1, for example. Further, claimed subject matter may include additional blocks or alternatives other than those shown in FIG. 2 and/or may include blocks occurring in different orders than shown and/or described.

At block 210, one or more computing platforms may generate and/or access signals and/or states relating to entry of one or more POPs listing property features. For example, a REP may enter one or more features of a POPs listing utilizing a computing platform, such as, for example, 102, shown in FIG. 1, for example, which may at least in part be stored by and/or accessed from computing platform 112, such as via network 110. As one non-limiting example, a browser, such as a web browser, may executed on a client device, such as computing platform 102. Via a web browser, an REP may access a secure website, for example, such as may reside on one or more servers, again, as one illustrative example, computing platform 112 may provide an example of a server. Thus, an REP may enter and/or modify content to a secure web site which may be included in a computing and/or communication network for REPs, as further described.

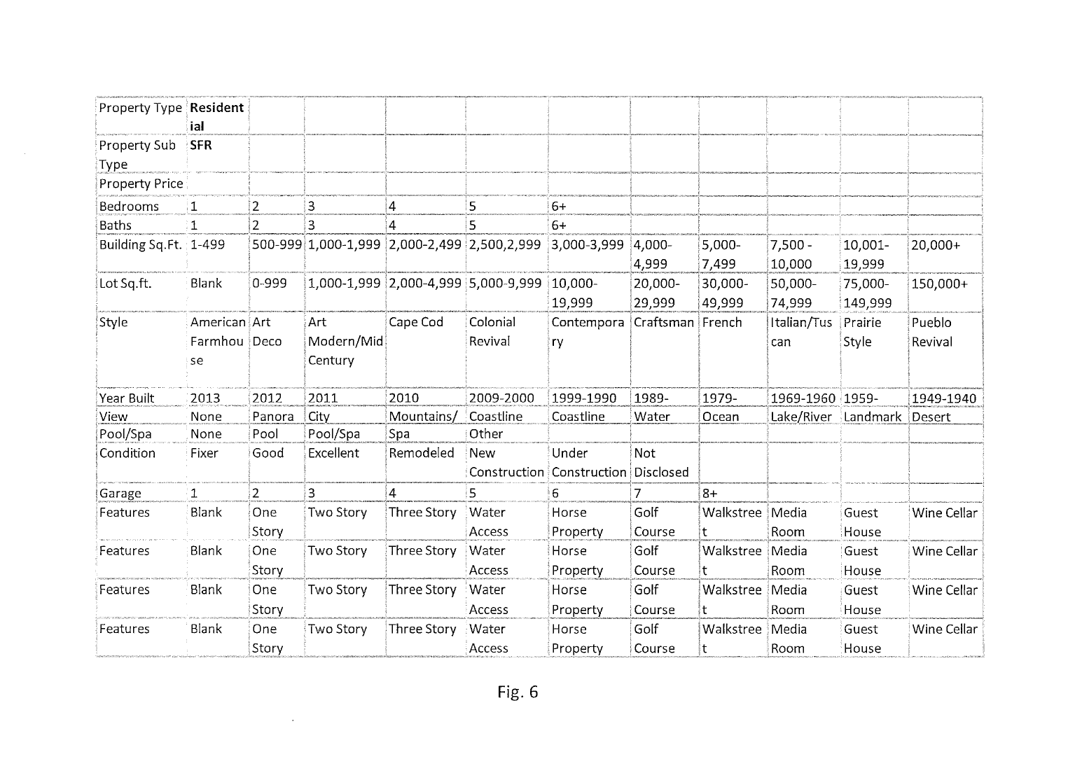

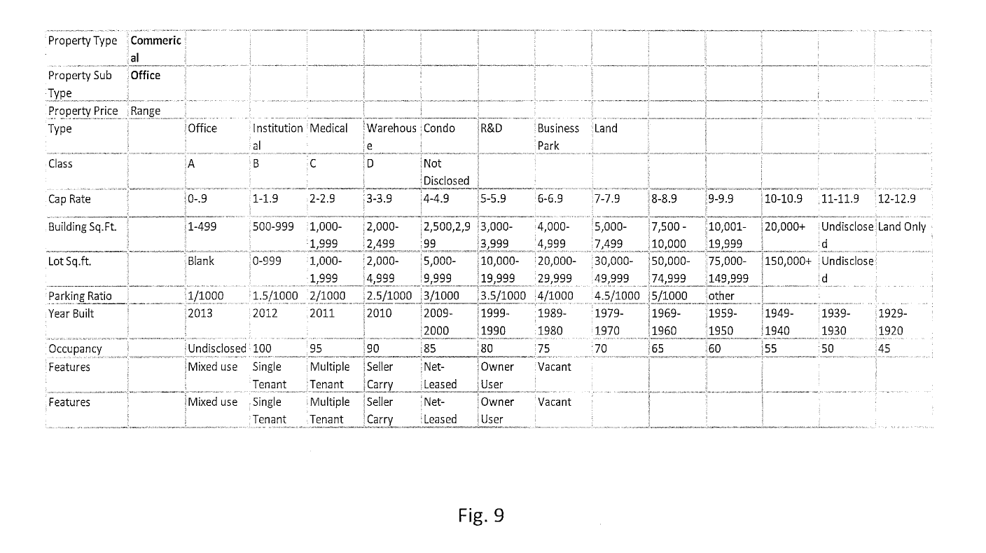

In this context, a POPs listing feature may comprise one or more descriptive features and/or characteristics of a property, referred to generally herein as content. In general, content refers to text, video, images, audio, etc, in the form of electrical signals, if being transmitted or received, for example, or in the form memory states, if being stored. Thus, as non-limiting examples of content, text, video, images, audio, etc., are represented by electrical signals and/or physical states so as to be capable of being processed and/or communicated electrically, for example. As non-limiting examples of content, POPs listing property features may include a property's geographic location, such as a zip code, a property type, such as residential or commercial, a property sub-type, such as a condo, a property listing price or listing range, and/or other characteristics, such as number of bedrooms or bathrooms, square footage, property amenities, a custom description, property photos, and the like, as non-limiting examples. Suffice to say, an exhaustive list of POPs listing property features that may be entered at block 210, such as for storage by a web server and/or a database accessible via a network, such as a private network, shall not be provided here. However, FIGS. 6-9 are included to illustrate a listing of some example POPs listing property features that may be entered, such as shown by block 210. It should, however, be noted that the above examples of POPs listing property features, and the POPs listing property features depicted are merely illustrative examples and that claimed subject matter is not limited in scope in this regard.

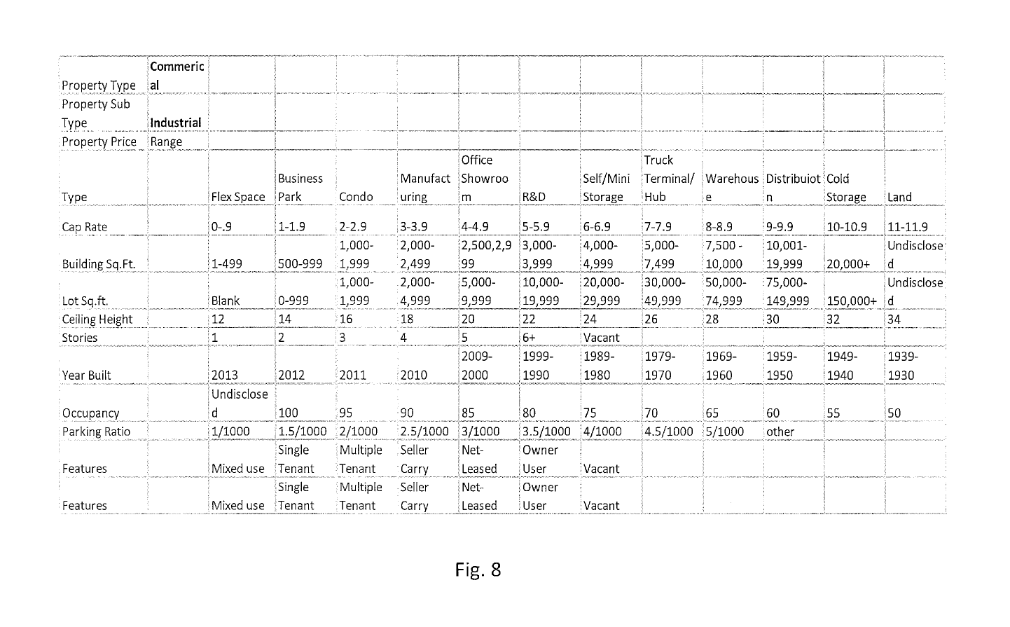

To further illustrate, referring to FIG. 8, for example, suppose an REP is entering POPs listing property features for an industrial business park. An REP may choose to list a cap rate of 5.72, a building sq. ft. of 8550, a year built of 1972, and that the property may extend a NNN lease for a 5-year term. Of course, these are merely examples and an REP may enter one or a combination of property features not depicted, for example. Here, however, it is noted that quantitative and/or qualitative property features depicted, for convenience, but without limitation, are depicted in English and in conventional U.S. real estate market units. For instance, sq. ft. is used, not meters squared, or m², as just an example, and prices may be depicted is USD, not another currency. Of course, as mentioned above, claimed subject matter is not limited by these illustrative examples.

In certain embodiments, an REP may not list a geographic description, such as property address, at block 210. Also, an REP may choose to not enter client related content, such as a client's name or other identifying content, as non-limiting examples. Thus, a client may or may not be associated with a particular POPs listing. In addition, in an embodiment, for example, an REP may electronically choose or set an appropriate level of permissions at block 230 which may designate which REPs, if any, may view and/or access that REP's POPs listings. Designation of permissions electronically, such as for one or more embodiments, will be discussed in more detail below in connection with block 230.

At block 220, one or more computing platforms may be employed to save and/or edit a POPs listing. For example, a REP may select to save a newly created POPs listing and/or edit one or more features or settings of an existing POPs listing, as non-limiting examples, utilizing computing platform 102 in FIG. 1, via network 110, in the manner previously described, for example. However, of course, this is merely one illustrative embodiment. Various other approaches are available and may be employed in alternative embodiments to communicate network transmissions.

In certain embodiments, features associated with one or more particular POPs listings may be saved under a profile stored in a database and/or on a server, such as 112, for example, and, thus, may in an embodiment be associated with a particular REP who may have entered one or more POPs listings, for example. Thus, a particular REP may edit, delete, etc., one or more POPs listings that the particular REP created previously, such as by logging onto his or her REP profile via a secure web site, for example.

At block 230, an appropriate level of electronic permission for a POPs listing may be established or set, such as by using computing platform 102 to electronically communicate with computing platform 112, which has the particular POPs listing stored in this non-limiting illustrative example. As mentioned above, an REP may electronically designate one or more permissions for a POPs listing. Designating permission electronically, in an embodiment, for example, may allow an REP to control access to one or more POPs listings, as described below.

In this manner, for an embodiment, REPs may be afforded confidentiality for his or her POPs listing in several ways. In general, in this embodiment example, to access a computing and/or communication network as described, one is expected to be a member; this means, in this case, an REP. In addition, it takes being granted express permission electronically, in this embodiment, for example, to access a POPs listing of another REP in the network. Furthermore, electronically granting of permission for another REP to access a POPs listing, for example, may potentially facilitate REP to REP interaction and/or communication, a desirable outcome in a situation such as this, for example. Likewise, in an embodiment, if permission is electronically granted, an REP being granted permission may be alerted electronically. Of course, it is appreciated that embodiments described, such as this example, are provided for purposes of illustration and claimed subject matter is so not limited. For example, an embodiment may or may not electronically alert an REP that permission is granted to access a POPs listing. Likewise, instead, an REP granted permission may communicate directly via another mechanism, for example.

Of course, any one of a host of mechanisms or approaches may be employed to determine whether to provide access to one or more POPs listings. To illustrate a few non-limiting examples, in one embodiment, a particular REP may designate that other REPs in the network that meet a certain threshold combination of performance, location and/or expertise may access a particular POPs listing. A designation may, for example, be based at least in part on a computed composite score and/or based at least in part on a particular combination of separate scores, for example, substantially in accordance with customized or universally employed criteria. Likewise, a particular REP may designate that only REPs meeting or exceeding a threshold score may access one listing, all listings or a subset of listings of the particular REP, as just an example.

A large variety of alternative approaches is possible and may be limited primarily by desires of a given REP; making the capability to customize access by POPs listing and/or by REP-to-REP a desirable feature for an embodiment. In one embodiment, electronically granted permissions may be based at least in part on other types of considerations in addition or alternatively, such as an REP's designations (e.g., CRS, GRI, ePro, etc.), REP sales in zip code, REP sales over price point, and the like, as non-limiting examples. Again, permission to access a POPs listing by an REP may vary for any particular POPs listing and/or any particular REP, as just an example.

FIG. 3 is a flow diagram illustrating another embodiment 300 of a method that may be employed in conjunction with a communication network for REPs, for example. Method embodiment 300 of FIG. 3, along with other figures shown and/or described herein, may be performed by computing device 112, for example, although nothing prevents performing other method embodiments within claimed subject matter. Likewise, a method embodiment, such as embodiment 300, may be performed by way of other arrangements other than embodiment 100, for example, shown in FIG. 1, for example. Further, claimed subject matter may include additional blocks or alternatives other than those shown in FIG. 3 and/or may include blocks occurring in different orders than shown and/or described.

As previously discussed, as a non-limiting example, one or more computing platforms, such as 102 in FIG. 1, for example, may, via a network, such as 110, access a computing platform, such as 112, which may, for example, include a database and/or may operate as a server to store a secure web site, as an example, capable of being accessed by REP members, for example, such as by executed a web browser on a client device, for example. Thus, in an illustrative situation, an REP representing a buyer may enter buyer-related content, as illustrated by block 310.

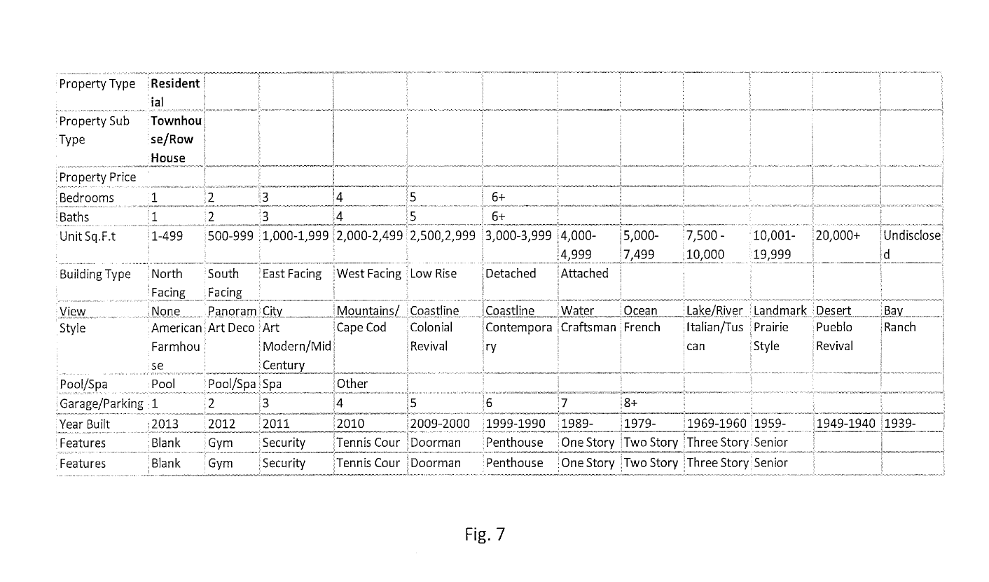

For example, an REP representing a buyer may desire to enter buyer related content in an attempt to identify one or more POPs listings, such as one or more POPs listings previously created and stored, for example, by a process of content entry and modification potentially similar to the embodiment depicted in FIG. 2, for example. Entering buyer related content may comprise entry of one or more POPs listing features, such as depicted in FIGS. 6-9, as a non-limiting example. Thus, as just an example, an REP representing a buyer interested in purchasing a residential townhome may enter one or more features depicted in FIG. 7, as just an example. In certain embodiments, an REP representing a buyer may also enter identifying content, such as name, address, etc., and store entered content via that REP's profile, accessible via computing platform 112, in this illustrative example.

Embodiments of comparison operations, such as matching, have been discussed previously. Of course, as previously explained, any one of a host of approaches are possible and claimed subject matter is not limited in scope to a particular approach. Nonetheless, with previously described illustrative embodiments in mind, for example, without loss of generality, at block 320, one or more computing platforms may score, for example, in one embodiment, buyer related content, entered, for example, at block 310, as well as score one or more features of one or more POPs listings.

In one implementation, for example, one or more POPs listing property features and buyer related content may be compared for similarity or dissimilarity, such as via scoring, for example, and without limitation, for identification purposes in this non-limiting illustrative example. Comparison techniques, or the like, may, for example, be executed by computing platform 112 in an embodiment, as just an example. Of course, in alternate embodiments, multiple computing platforms and/or databases, for example, may be included in implementations. Likewise, type of comparison may in some embodiments comprise a user specified feature, such as, for example, from a drop down menu, as one simple example.

Without limitation, but by way of illustration, for example, a user may specify features for comparison, such as, without limitation, particular ranges, acceptable thresholds, individually and/or in various combinations, etc. etc. For example, in an embodiment, comparisons may be performed in conjunction with one or more stored indexes of features, such as may include features of properties being sought or being offered, whether for sale or lease, for example. If no POPs listings are identified at block 320, similar to a previously described example associated with FIG. 2, in an embodiment, an REP may chose here to edit buyer related content.

However, if one or more POPs listings are identified at block 320, at block 330, one or more computing platforms, such as 112, for example, may determine whether access has been granted electronically, in an embodiment. For example, at block 330, scoring using performance, location, expertise, and/or combinations thereof, as previously discussed, in an illustrative embodiment, for example, may affect a determination regarding whether a REP having entered buyer related content has been electronically granted permission to access an identified POPs listing of another REP, for example. As illustrated, for example, by block 340, if the REP having entered buyer related content does not have permission, that REP may choose to request permission electronically at block 340.

Again, any one of a number of implementation approaches are possible and intended to be included within claimed subject matter. For example, an REP having entered buyer related content may electronically receive a notification or alert that one or more POPs listings have been identified, but that one or more are not accessible without express electronic permission from the one or more REPs that may have entered the one or more identified POPs listings. For example, computing platform 112 may initiate an electronic transmission via network 110 to computing platforms 102, 104, 114 or 118 (it is assumed here, for illustration, that there represent client devices for the relevant REPs to be alerted), for example, in this illustration, altering the one or more REPs that another REP, here an REP representing a buyer, has potential interest in one or more POPs listings but is unable to access the one or more POPs listings without express permission being electronically granted. Alternatively or in addition, the REP representing the buyer may be provided information about the one or more REPs that entered the one or more identified POPs listings and may be provided an opportunity to electronically communicate with those one or more REPs, as just an example, in order to request permission to electronically access the one or more POPs listings or otherwise arrange to have a discussion. Of course, if electronic permission was or is granted to access the one or more POPs listings, in an embodiment, POPs listing related content, for example, may be provided or displayed. For example, without limitation, in an embodiment, Here, for example, computing platform 112 may serve one or more secure webpages or serve other content via another mechanism to a client computing platform of the REP that entered the buyer related content.

Thus, in an embodiment, an REP may gain access to one or more POPs listings listed by one or more REPs. Of course, as previously indicated, electronic permission may be customized in an embodiment. Thus, for example, an REP may designate different levels of access and/or for different situations. For example, an REP may set access at a base threshold level, for example, to provide price, square footage, and/or amenities of a POPs listing. However, higher levels of electronic permission, for example, may provide additional access about a POPs listing, such as its geographic location, photos, a custom description, and the like, as just some examples. Threshold levels, of course, in different embodiments and/or different situations may be set in a variety of ways. For example, scoring a combination of performance, location, expertise may be employed and/or a REP may choose to set electronic permission level or threshold on a case by case basis after an electronic request, as just an example.

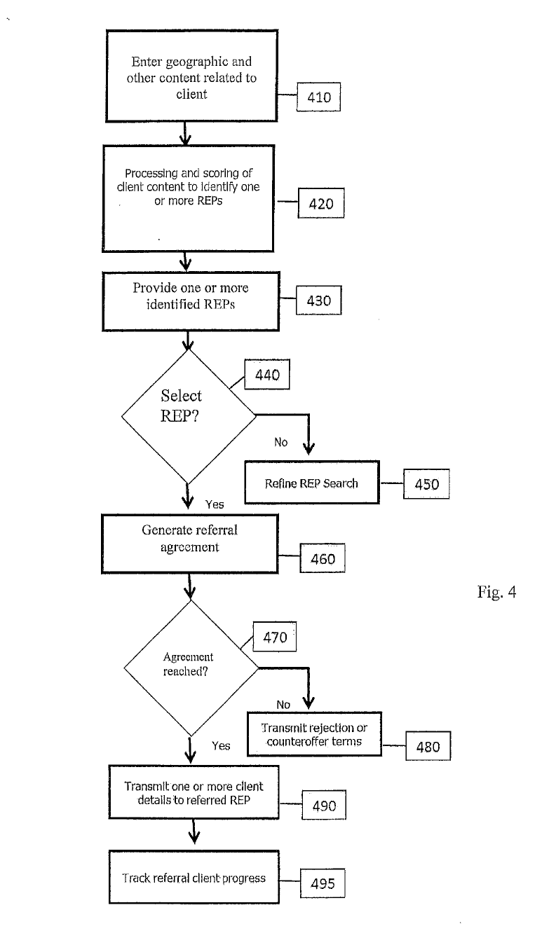

FIG. 4 is a flow diagram illustrating another embodiment 400 of a method that may be employed in conjunction with a communication network for REPs, for example. Method embodiment 400 of FIG. 4, along with other figures shown and/or described herein, may be performed by computing device 112, for example, although nothing prevents performing other method embodiments within claimed subject matter. Likewise, a method embodiment, such as embodiment 400, may be performed by way of other arrangements other than embodiment 100, for example, shown in FIG. 1, for example. Further, claimed subject matter may include additional blocks or alternatives other than those shown in FIG. 4 and/or may include blocks occurring in different orders than shown and/or described.

As mentioned previously, at times an REP may represent a client, such as a buyer, but the REP may be unable to assist the client in a geographic area in which the client may be interested in buying, selling, leasing, etc., a property. Thus, an REP may desire to identify another REP in the client's geographic area of interest.

Accordingly, at block 410, a referring REP may enter geographic related content, such as an SCF code (e.g., a three digit zip code prefix), a ZIP code, a country, state, county, city, neighborhood, etc., to designate a geographic area to locate a referral REP, for example. Also, at block 410, a referring REP may enter one or more items depicting client interest, such as one or more buyer, seller, lessee, lessor, etc., features, for example. Again, for illustrative purposes, referring to FIGS. 6-9, examples of features may include: a buyer desires a 0.5 acre view lot in 94309, or a seller desires to sell his warehouse business in Van Nuys, Calif., or a lessee or lessor wants to offer or obtain lease property having one or more specific geographic or features criteria, and so forth.

Also, at block 410, a referring REP may enter for one more criteria or values, such as scores, to identify one or more referral REPs meeting and/or exceeding a certain level of performance and/or expertise. As previously described, for example, a client device, such as computing platform 102 in FIG. 1, as an example, may execute a web browser that may be employed to establish electronic communications with a secure web site, for example, such as via a VPN, as an example.

At block 420, one or more computing platforms, such as 112, for example, may perform processing to generate potential or at least partial matches of one or more REPs based, at least in part, on processing of measurements, such as combinations of performance, location and/or expertise, such as via a scoring technique, for example, although claimed subject matter is not limited in scope in this respect.

As a simple illustration, in an embodiment, one or more computing platforms, such as computing platform 112, may compare geographic related content to identify one or more REPs corresponding to geographic locations entered via a client device. In certain embodiments, geographic related content may be used to identify referral REPs. Comparison operations may utilize one or more operations previously described, but claimed subject matter is, of course, not limited in scope in this respect. Nonetheless, in an embodiment, after a geographic comparison is made, one or more computing platforms may provide one or more referral REPs, depicted at block 430.

In a more complicated illustration, in an embodiment, one or more computing platforms, such as computing platform 112, may additionally compare one or more referral REP's performance and/or expertise along with geographic related content, to identify a potential for an at least partial match, for example. Thus, in certain embodiments, one or more computing platforms, such as computing platform 112, may score REPs in a network. To illustrate, Table 1, below, depicts some illustrative examples of measurements which may be taken into account to compute an REP score in an embodiment.

For example, Table 1 depicts a raw, or unadjusted, REP score that may be computed by factoring in an REP's location (depicted here by an SCF code) and determining a product of REP sides, REP referrals and REP POPs listings, for example. Of course, claimed subject matter is not limited in scope to this illustrative example. In this context, nonetheless, a REP side comprises number of times an REP has represented a client. Thus, for example, if a REP represents a buyer in a particular transaction, the REP has one side. If the REP represents both the buyer and the seller, the REP has two sides. Also, referrals in Table 1 may be determined substantially in accordance with number of referrals a particular REP has sent and/or received via participation in an REP communication network, for example. Similarly, POPs listing in Table 1 may be determined substantially in accordance with number of POPs listings a particular REP has listed or entered through participation in an REP communication network, again, as an example.

In certain embodiments, Table 1 may be verified or may be gleaned from public records, tax records, and/or third-party sources such as escrow companies, online marketplaces/database, such as LoopNet® and/or MLS®, or the like, as non-limiting examples. To illustrate a raw score computation, REP M. Ilani, on the third row of Table 1, has an SCF of 902, sides of 32×2 (64), 15×2 (30), referrals of 10, 2, and POPs listings of 14,12. Accordingly, a raw score for M. Ilani is 132, or the product of 64+30+10+2+14+12. Here, for the 902 SCF, that puts M. Ilani's score in the 83% vis-à-vis other REPs in the 902 SCF (e.g., percentage rank based, at least in part, on REP's relative positioning with respect to other REP's raw scores).

TABLE 1

| | | | | Sides | | Referrals | | POP | | | | | |
|---|---|---|---|---|---|---|---|---|---|---|---|---|---|
| | | | | 2 | 2 | 1 | 1 | 1 | 1 | AB Score | | | |
| First | Last | ZIP | SCF | Buyer | Seller | Out | In | Pockets | Buyers | Raw | % | Adj | Displayed |
| I | Dee | 90236 | 902 | 31 | 39 | 6 | 10 | 6 | 12 | 174 | 100% | 100 | 100 |
| B | Smith | 90275 | 902 | 26 | 25 | 16 | 9 | 13 | 8 | 148 | 91% | 95 | 95 |
| M | Ilani | 90276 | 902 | 32 | 15 | 10 | 2 | 14 | 12 | 132 | 83% | 92 | 92 |
| H | Zoe | 90287 | 902 | 15 | 28 | 15 | 5 | 6 | 15 | 127 | 75% | 87 | 87 |
| A | Edler | 90274 | 902 | 24 | 14 | 8 | 10 | 15 | 12 | 121 | 66% | 82 | 82 |
| K | Jen | 90205 | 902 | 25 | 19 | 13 | 4 | 13 | 1 | 119 | 58% | 78 | 78 |
| J | Mikel | 90277 | 902 | 27 | 17 | 7 | 7 | 6 | 8 | 116 | 50% | 74 | 74 |
| E | Sophie | 90277 | 902 | 4 | 34 | 17 | 1 | 1 | 19 | 114 | 41% | 70 | 70 |
| C | Rick | 90245 | 902 | 21 | 20 | 11 | 0 | 9 | 6 | 108 | 33% | 66 | 66 |
| D | Mark | 90278 | 902 | 18 | 6 | 0 | 0 | 10 | 20 | 78 | 25% | 62 | 62 |
| N | Ken | 90245 | 902 | 1 | 23 | 0 | 11 | 8 | 10 | 77 | 16% | 57 | 57 |
| F | Ryder | 90214 | 902 | 3 | 18 | 14 | 0 | 0 | 11 | 67 | 8% | 53 | 53 |
| L | Taylor | 90245 | 902 | 6 | 10 | 3 | 10 | 11 | 5 | 61 | 0% | 50 | 50 |

In addition, in certain embodiments, a raw score may be adjusted. For example, in an embodiment, adjustments may, for example, comprise normalization, such as an adjustment made utilizing REP sides, which may alter scores to more accurately reflect REP performance and/or expertise across a spectrum of varying real estate markets. Here, it is noted that an estimate of relative value, such as estimate via relative value unit, may be employed to accomplish normalization in an embodiment. Of course, a host of normalization techniques are known, available, and/or may be developed and claimed subject matter is not limited in scope to a particular approach. For example, implementations may make use of techniques, such as weighted summations, regressions, and/or other techniques, to provide a few examples. It is not intended that claimed subject matter be limited in scope to a particular approach to normalization.

TABLE 2

| | AB Score | AB Score |
|---|---|---|
| Top X % | Adjusted | Displayed |
| 0% | 49.8 | 50 |
| 1% | 49.9 | 50 |
| 2% | 50 | 50 |
| 3% | 50.9 | 51 |
| 4% | 51 | 51 |
| 5% | 51.9 | 52 |
| 6% | 52 | 52 |
| 7% | 52.9 | 53 |
| 8% | 53 | 53 |
| 9% | 53.9 | 54 |
| 10% | 54 | 54 |
| 11% | 54.9 | 55 |
| 12% | 55 | 55 |
| 13% | 55.9 | 56 |
| 14% | 56 | 56 |
| 15% | 56.9 | 57 |
| 16% | 57 | 57 |
| 17% | 57.9 | 58 |
| 18% | 58 | 58 |
| 19% | 58.9 | 59 |
| 20% | 59 | 59 |
| 21% | 59.9 | 60 |
| 22% | 60 | 60 |
| 23% | 60.9 | 61 |
| 24% | 61 | 61 |
| 25% | 61.9 | 62 |
| 26% | 62 | 62 |
| 27% | 62.9 | 63 |
| 28% | 63 | 63 |
| 29% | 63.9 | 64 |
| 30% | 64 | 64 |
| 31% | 64.9 | 65 |
| 32% | 65 | 65 |
| 33% | 65.9 | 66 |
| 34% | 66 | 66 |
| 35% | 66.9 | 67 |
| 36% | 67 | 67 |
| 37% | 67.9 | 68 |
| 38% | 68 | 68 |
| 39% | 68.9 | 69 |
| 40% | 69 | 69 |
| 41% | 69.9 | 70 |
| 42% | 70 | 70 |
| 43% | 70.9 | 71 |
| 44% | 71 | 71 |
| 45% | 71.9 | 72 |
| 46% | 72 | 72 |
| 47% | 72.9 | 73 |
| 48% | 73 | 73 |
| 49% | 73.9 | 74 |
| 50% | 74 | 74 |
| 51% | 74.9 | 75 |
| 52% | 75 | 75 |
| 53% | 75.9 | 76 |
| 54% | 76 | 76 |
| 55% | 76.9 | 77 |
| 56% | 77 | 77 |
| 57% | 77.9 | 78 |
| 58% | 78 | 78 |
| 59% | 78.9 | 79 |
| 60% | 79 | 79 |
| 61% | 79.9 | 80 |
| 62% | 80 | 80 |
| 63% | 80.9 | 81 |
| 64% | 81 | 81 |
| 65% | 81.9 | 82 |
| 66% | 82 | 82 |
| 67% | 82.9 | 83 |
| 68% | 83 | 83 |
| 69% | 83.9 | 84 |
| 70% | 84 | 84 |
| 71% | 85 | 85 |
| 72% | 85.8 | 86 |
| 73% | 85.9 | 86 |
| 74% | 86 | 86 |
| 75% | 86.9 | 87 |
| 76% | 87 | 87 |
| 77% | 87.9 | 88 |
| 78% | 88 | 88 |
| 79% | 88.9 | 89 |
| 80% | 89 | 89 |
| 81% | 90 | 90 |
| 82% | 91 | 91 |
| 83% | 91.9 | 92 |
| 84% | 92 | 92 |
| 85% | 92.8 | 93 |
| 86% | 92.9 | 93 |
| 87% | 93 | 93 |
| 88% | 93.8 | 94 |
| 89% | 93.9 | 94 |
| 90% | 94 | 94 |
| 91% | 94.9 | 95 |
| 92% | 95 | 95 |
| 93% | 95.9 | 96 |
| 94% | 96 | 96 |
| 95% | 96.9 | 97 |
| 96% | 97 | 97 |
| 97% | 97.9 | 98 |
| 98% | 98 | 98 |
| 99% | 99.9 | 100 |
| 100% | 100 | 100 |

With reference to Table 2 above, Table 2 may show a set of normalization values for the 902 SCF. Of course, this table is merely illustrative, and other geographic areas, such as depicted by an SCF, may use other sets of normalization values. Referring again to Table 2, M. Ilani's computed score in the 902 SCF of 83% corresponds to an adjusted REP score of 91.2, which, as depicted above, results in a displayed score of 92. Here, it is noted that example scores in Tables 1 and 2 are depicted as being between a minimum of 50 and a maximum of 100, with a base score of zero.

Returning to block 420, at FIG. 4, as mentioned above, one or more computing platforms may compare one or more REPs based, at least in part, on processing measurements of combinations of performance, location and/or expertise. Thus, in certain embodiments, a referring REP may indicate that he or she desires to identify referral REPs meeting or exceeding a particular raw or adjusted score for a particular geographic location, as just an example.

After scoring is performed, at block 430, one or more computing platforms may provide one or more REPs for referral as a consequence of scoring. For example, computing platform 112 may serve one or more webpages providing one or more referral REPs. In certain embodiments, a plurality of identified referral REPs may be sorted or filtered, by default settings and/or by a referring REP, in a variety of ways, such as first providing REPs in the referring professional's network, then providing REPs with more referrals plus one or more pocket listings in selected geographic area, then REPs with average sales price closest to geographic average sales price and one or more pocket listings in geographic area, as just some non-limiting examples. In certain embodiments, a plurality of identified referral REPs may be sorted or filtered by their corresponding raw or adjusted score, as just another example. If a referring REP does not find a referral REP that is considered satisfactory, a referring REP may choose to refine his or her search, as depicted by block 450. At block 440, a referring REP may electronically select one or more referral REPs provided at block 430, such as via interacting through a web browser executing on a client device, for example.

After a referring REP has selected a referral REP, at block 460, one or more computing platforms may generate a referral agreement. Here, for example, a referring REP may, for example, choose to enter various referral fee agreement terms, which may then be incorporated into a generated referral fee agreement. Terms, as non-limiting examples, may comprise specifying referral fee amount, timing of referral fee payment, spelling out contingencies, and the like. After a referring REP is satisfied with terms of a generated referral fee agreement, at block 460, a referring REP may electronically transmit the agreement to a referral REP via any one of a host of techniques which may be made available via an REP communication network and/or secure web site, such as, for example, by emailing, faxing, displaying a notification icon on a referral REPs profile, or otherwise transmitting the referral fee agreement to the referral REP. Of course, claimed subject matter is not limited in scope to an illustrative example, such as previously described.

In certain embodiments, a referral fee agreement may, of course, be generated such that it appropriately conforms to laws, regulations, rules, etc., of appropriately governing jurisdictions and licensing boards applicable for the referring REP and referral REP. At block 470, a referral REP may review terms of the referral agreement and accept, reject or counter those terms. Acceptance, rejection and/or counteroffer terms may be electronically communicated to a referring REP at block 480, for example. Here, negotiations may last for several iterations and there may be one or more electronic exchanges of REP communications before an agreement is reached, if at all. Likewise, negotiations may take place via another communication mechanism or approach, such as offline.

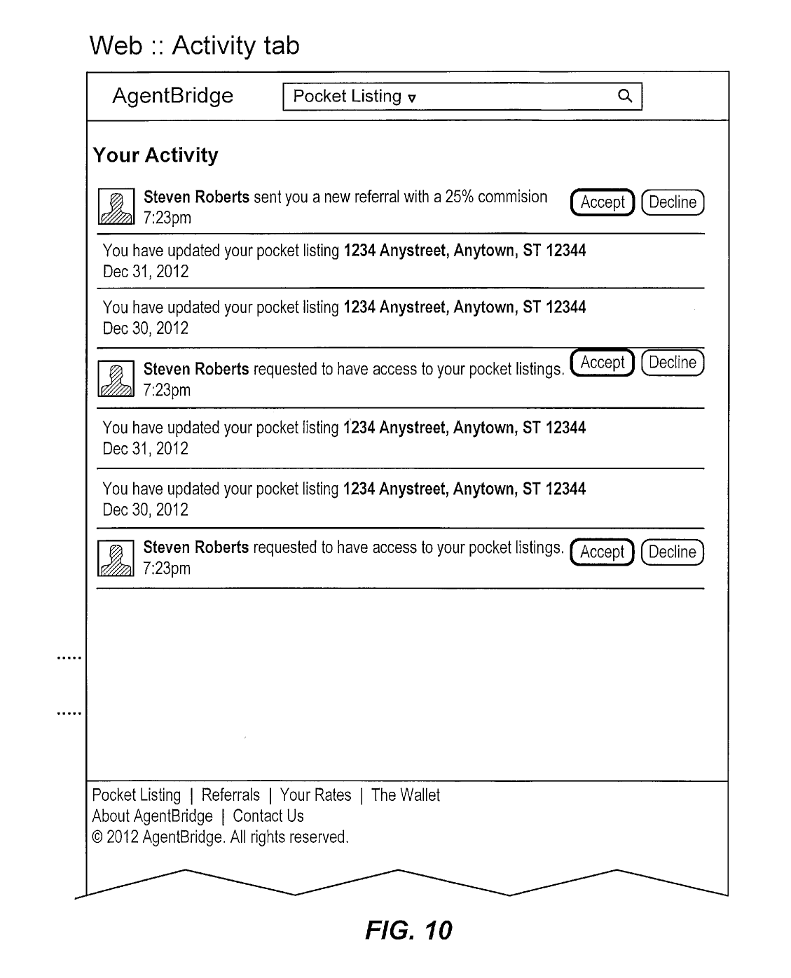

After a referral REP has electronically accepted a referral agreement so as to consummate it as between the REPs, at block 470, one or more computing platforms may transmit one or more client details. Here, a referring REP may determine an appropriate amount of client related content to share, for example, such as via an REP communication network, such as previously described, for example. At block 495, a referring REP may also in an embodiment track referral client progress. For example, in an embodiment, one or more computing platforms, such as computing platform 112, may track client progress updates and provide such updates as part of a referring REP's profile. For example, FIG. 10 depicts a sample webpage which may be served to an ultimately displayed on a client device, such as computing platform 102, for a particular REP profile. As another example, computing platform 112 may compile content from public records, such as county tax records, and or third-parties, such as escrow companies, online databases, such as MLS® services and/or LoopNet® services, to generate electronic updates for referred clients. Electronic updates may include, for example, whether escrow has been opened for a referred client's transaction, if an inspection has taken place, whether earnest money has been tendered, and/or the like. Thus, in certain embodiments, electronic status updates may be generated by computing platform 112, such as by reviewing records accessible via network 110. In certain embodiments, electronic or other status updates may be made by a referral REP, as yet another example.

There may be several advantages to particular embodiments, such as, for example, previously described, although claimed subject matter is not limited in scope to a particular advantage. For example, in one embodiment, one advantage may be that an REP may be able to prospectively assess market interest and/or set a market price, which may, for example, lead to a more accurate sales price and/or a faster sale with less time, effort, cost, etc. In one embodiment, an advantage may be that a referring REP may more easily and/or accurately, search for and identify a referral REP and/or consummate a referral fee agreement. In one embodiment, another advantage may be that a REP may be able to maintain his or her involvement in a transaction and/or perform better tracking of transactions progress. For example, a particular REP may be able to better control access by other REPs to that particular REP's POPs listings, and the particular REP may maintain better control over referrals, transaction involvement, transaction progress, etc. Correspondingly, one advantage of maintaining better control over POPs listings by a particular REP may be to facilitate generating sub-markets, so to speak, where, in effect, an REP member of an embodiment of a computing and/or communication network for REPs, as described, for example, is able to maintain lists of POPs listings to share, or not share, with other REP embers of the network.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more concept(s) described herein. Therefore, it is intended that claimed subject matter not be limited to the particular examples disclosed, but that such claimed subject matter may also include all aspects falling within appended claims and/or equivalents thereof.

1. A method comprising:
establishing a real estate professional communication network comprising one or more servers;
matching real estate REPs in the network based at least in part on measurements of combinations of performance, location and/or expertise.

2. The method of claim 1, wherein the real estate communication network comprises a private network.

3. The method of claim 2, wherein communications of the private network are capable of being exchanged via a virtual private network over the Internet.

4. The method of claim 1, wherein the matching based at least in part on measurements comprises:
scoring measured parameters for members of the network.

5. The method of claim 1, wherein the measurements of combinations includes an estimate of a deterministic portion of member performance.

6. The method of claim 1, wherein the measurements of combinations includes an estimate of a deterministic portion of member expertise.

7. An apparatus comprising:
a real estate professional communication network comprising one or more servers;
wherein at least one of the one or more servers is operable to match real estate REPs in the network based at least in part on measurements of combinations of performance, location and/or expertise.

8. The apparatus of claim 7, wherein the real estate professional communication network comprises a private network.

9. The apparatus of claim 8, wherein the real estate professional communication network is operable so that communications of the private network are capable of being exchanged via a virtual private network over the Internet.

10. The apparatus of claim 7, wherein the at least one of the one or more servers operable to match real estate REPs in the network based at least in part on measurements comprises: the at least one of the servers being operation to score measured parameters for members of the network.

11. The apparatus of claim 7, wherein the measurements of combinations includes an estimate of a deterministic portion of member performance.

12. The apparatus of claim 7, wherein the measurements of combinations includes an estimate of a deterministic portion of member expertise.

13. A method comprising:
generating a secure, private network for REP to REP communications to facilitate one or more RE transactions in one or more POPs listings; wherein the particular property that is the subject of the one or more POPs listings and its owner are not identified in the communications.

14. The method of claim 13, wherein the communications for the secure, private network are capable of being exchanged via a secure web site.

15. The method of claim 13, wherein the communications for the secure, private network are capable of being exchanged via secure communication transmissions.

16. The method of claim 13, wherein the secure, private network includes a capability to catalog POPs listings for an REP, wherein the particular property that is the subject of the one or more POPs listings and its owner are not identified in the catalog of POPs listings.

17. The method of claim 16, wherein the secure, private network includes a capability to survey a range of prices for a future transaction via comparisons with POPs listings cataloged in similar or different markets using a comparison of POPs listing property features.

18. The method of claim 17, wherein the secure, private network includes a capability to survey a range of prices for a future transaction via comparisons with POPs listings cataloged in similar or different markets using a normalized comparison of POPs listing property features.

19. The method of claim 17, wherein the secure, private network includes a capability to survey a range of prices for a future transaction via comparisons with POPs listings cataloged in similar or different markets using a normalized comparison of POPs listing property features to estimate a market value.

20. The method of claim 13, wherein the secure, private network includes a capability to generate a profile for an REP.

21. The method of claim 20, wherein the secure, private network includes a capability to alert REPs regarding a potential match without identifying either REP to the other unless permission to do so is electronically granted.

22. The method of claim 21, wherein the capability to alert REPs includes a capability for the REP to request alerts substantially in accordance with preferences selected electronically.

23. The method of claim 21, wherein preferences capable of being selected electronically include RE features, time periods, geographic locations, REP profiles, or any combinations thereof.

24. The method of claim 21, wherein a potential match includes at least one of the following: achieving an adequate score for performance and/or expertise for both REPs; corresponding features between one or more cataloged POPs listings and cataloged buyer related content; overlap in value for one or more cataloged POPs listings and cataloged buyer related content; or any combinations thereof.

25. The method of claim 24, wherein value for one or more cataloged POPs listings comprises a normalized value.

26. The method of claim 21, wherein permission may be granted on a transaction basis or on an on-going basis unless withdrawn.

27. The method of claim 13, wherein the one or more RE transactions in one or more POPs listings includes transactions in residential RE, transactions in commercial RE, and/or rentals thereof.

28. A method comprising:
participating in a private electronic network of REPs via electronic communications with a secure website;
wherein said participating includes generating an REP profile and at least one POPs listing.

29. The method of claim 28, wherein said participating further includes entering buyer related content to identify one or more POPs listings.

30. The method of claim 28, wherein said electronic communications take place via a client device; and wherein said participating comprises participating via said client device.

31. An apparatus comprising:
a secure, private network for REP to REP communications to facilitate one or more RE transactions in one or more POPs listings; wherein the particular property that is the subject of the one or more POPs listings and its owner are not identified.

32. The apparatus of claim 31, wherein communications for the secure, private network are capable of being exchanged via a secure web site.

33. The apparatus of claim 31, wherein communications for the secure, private network are capable of being exchanged via secure communication transmissions.

34. The apparatus of claim 31, wherein the secure, private network is operable to catalog POPs listings for an REP without the particular property that is the subject of the one or more POPs listings and its owner not being identified.

35. The apparatus of claim 34, wherein the secure, private network is operable to survey a range of prices for a future transaction via comparisons with POPs listings cataloged in similar or different markets using a comparison of POPs listing property features.

36. The apparatus of claim 35, wherein the secure, private network is operable to survey a range of prices for a future transaction via comparisons with POPs listings cataloged in similar or different markets using a normalized comparison of POPs listing property features.

37. The apparatus of claim 36, wherein the secure, private network is operable to survey a range of prices for a future transaction via comparisons with POPs listings cataloged in similar or different markets using a normalized comparison of POPs listing property features to estimate a market value.

38. An article comprising: a non-transitory storage medium having stored thereon instructions capable of being executed by a computing device so as to generate a real estate professional communication network comprising one or more servers;
wherein at least one of the one or more servers is operable to match real estate REPs in the network based at least in part on measurements of combinations of performance, location and/or expertise.

39. An article comprising: a non-transitory storage medium having stored thereon instructions capable of being executed by a computing device so as to generate a secure, private network for REP to REP communications to facilitate one or more RE transactions in one or more POPs listings; wherein the particular property that is the subject of the one or more POPs listings and its owner are not identified.
